(19) United States
(12) Patent Application Publication
(10) Pub. No.: US 2017/0282294 A1
(43) Pub. Date: Oct. 5, 2017

(54) LASER BUILD-UP METHOD

(71) Applicant: TOYOTA JIDOSHA KABUSHIKI KAISHA, Toyota-shi (JP)

(72) Inventor: Keisuke Uchida, Nagoya-shi (JP)

(73) Assignee: TOYOTA JIDOSHA KABUSHIKI KAISHA, Toyota-shi (JP)

(21) Appl. No.: 15/439,068

(22) Filed: Feb. 22, 2017

(30) Foreign Application Priority Data
Apr. 4, 2016 (JP) 2016-075390

(51) Int. Cl. B23K 26/03; B23K 26/082; B23K 26/06; B23K 26/342; B33Y 10/00; B33Y 50/02

(52) U.S. Cl. CPC B23K 26/034; B33Y 10/00; B33Y 50/02; B23K 26/0626; B23K 26/342; B23K 26/082

(57) ABSTRACT

Provided is a laser build-up method capable of building up a layer with a uniform weld penetrating amount on first and second surfaces even when non-uniformity in distribution of supplied metallic powder due to the shape of a joint or the effect of gravity. A laser build-up method for a corner region formed by a first surface (11) and a second surface (12) in a different orientation from the first surface includes: supplying metallic powder (55) to the corner region; forming a melted part by performing weaving irradiation of a laser (25) on the first and second surfaces (11, 12) under a predetermined irradiation condition and melting the metallic powder (55); measuring a first temperature of the melted part of the first surface (11) and a second temperature of the melted part of the second surface (12); and setting the irradiation condition based on the first and second temperatures.

### CROSS-REFERENCE TO RELATED APPLICATION

This application is based upon and claims the benefit of priority from Japanese patent application No. 2016-075390, filed on Apr. 4, 2016, the disclosure of which is incorporated herein in its entirety by reference.

### TECHNICAL FIELD

The present invention relates to a laser build-up method. For example, the present invention relates to a laser build-up method for building up a layer on a workpiece by irradiating the workpiece with a laser while supplying metallic powder onto the workpiece.

### BACKGROUND

Japanese Unexamined Patent Application Publication No. H09-314343 discloses a method of building up a corner region formed by a first surface and a second surface in a different orientation from the first surface. In the build-up method disclosed in Japanese Unexamined Patent Application Publication No. H09-314343, chamfering the corner region facilitates the removal of heat from the corner region and enables build-up of the corner region with a uniform quality.

When the metallic powder is supplied to the corner region, non-uniformity in the distribution of supplied metallic powder may be caused due to the shape of a joint or the effect of gravity. Material defects, such as an occurrence of local burn-through in a region supplied with a small amount of metallic powder, or a welding failure in a region supplied with an excessive amount of metallic powder, occur.

The present invention has been made to solve the above-mentioned problem, and an object of the present invention is to provide a laser build-up method capable of building up a layer with a uniform weld penetrating amount on the first and second surfaces even when non-uniformity in the distribution of supplied metallic powder is caused due to the shape of a joint or the effect of gravity.

### SUMMARY

A first exemplary aspect of the present invention is a laser build-up method for a corner region formed by a first surface and a second surface in a different orientation from the first surface, the laser build-up method including: supplying metallic powder to the corner region; forming a melted part by performing a weaving irradiation of a laser on the first surface and the second surface under a predetermined irradiation condition and melting the metallic powder; measuring a first temperature of the melted part of the first surface and a second temperature of the melted part of the second surface; and setting the irradiation condition based on the first temperature and the second temperature. This configuration makes it possible to build up a layer with a uniform weld penetrating amount on the first and second surfaces even when non-uniformity in the distribution of supplied metallic powder is caused due to the shape of a joint or the effect of gravity.

When the first temperature is higher than the second temperature, an irradiation energy of the laser on the second surface is set to be larger than the irradiation energy of the laser on the first surface, and when the first temperature is lower than the second temperature, the irradiation energy of the laser on the first surface is set to be larger than the irradiation energy of the laser on the second surface. With this configuration, a variation in the input of heat on the first and second surfaces can be suppressed.

Further, when the first temperature is higher than the second temperature and a difference obtained by subtracting the second temperature from the first temperature is larger than a predetermined threshold, a scanning speed of the laser on the first surface is preferably set to be higher than the scanning speed of the laser on the second surface. When the first temperature is lower than the second temperature and a difference obtained by subtracting the first temperature from the second temperature is larger than the predetermined threshold, the scanning speed of the laser on the first surface is preferably set to be lower than the scanning speed of the laser on the second surface. With this configuration, a laser irradiation time for the surface with a lower temperature (surface supplied with a larger amount of metallic powder) is increased, which makes it possible to suppress the occurrence of non-welding, and a laser irradiation time for the surface with a higher temperature (surface supplied with a smaller amount of metallic powder) is reduced, which makes it possible to suppress the occurrence of burn-through.

When the first temperature is higher than the second temperature and a difference obtained by subtracting the second temperature from the first temperature is larger than a predetermined threshold, scanning of the laser is preferably interrupted for a certain period of time on the second surface. When the first temperature is lower than the second temperature and a difference obtained by subtracting the first temperature from the second temperature is larger than the predetermined threshold, scanning of the laser is preferably interrupted for a certain period of time on the first surface. With this configuration, a laser irradiation time for the surface with a lower temperature (surface supplied with a larger amount of metallic powder) is increased, which makes it possible to suppress the occurrence of non-welding, and a laser irradiation time for the surface with a higher temperature (surface supplied with a smaller amount of metallic powder) is reduced, which makes it possible to suppress the occurrence of burn-through.

According to an exemplary aspect of the present invention, it is possible to provide a laser build-up method capable of building up a layer with a uniform weld penetrating amount on the first and second surfaces even when non-uniformity in the distribution of supplied metallic powder is caused due to the shape of a joint or the effect of gravity.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a block diagram illustrating a laser build-up apparatus according to a first exemplary embodiment;

FIG. 2 is a diagram illustrating a laser build-up method according to the first exemplary embodiment;

FIG. 3 is a flowchart illustrating the laser build-up method according to the first exemplary embodiment;

FIG. 4A is a graph illustrating a temporal transition of a scanning speed in the laser build-up method according to the first exemplary embodiment, in which the horizontal axis represents time and the vertical axis represents the scanning speed;

FIG. 4B is a graph illustrating a temporal transition of a radiation temperature of a melt pool in the laser build-up method according to the first exemplary embodiment, in which the horizontal axis represents time and the vertical axis represents the radiation temperature of the melt pool;

FIG. 4C is a sectional view illustrating a cladding layer formed by the laser build-up method;

FIG. 5A is a graph illustrating a temporal position of a scanning speed in a laser build-up method according to Comparative Example 1, in which the horizontal axis represents time and the vertical axis represents the scanning speed;

FIG. 5B is a graph illustrating a temporal transition of a radiation temperature of a melt pool in the laser build-up method according to Comparative Example 1;

FIG. 5C is a sectional view illustrating a cladding layer formed by the laser build-up method according to Comparative Example 1;

FIG. 6 is a diagram illustrating a laser build-up method according to Comparative Example 2;

FIG. 7 is a flowchart illustrating a laser build-up method according to a second exemplary embodiment; and

FIG. 8 is a graph illustrating a temporal transition of a scanning speed in the laser build-up method according to the second exemplary embodiment, in which the horizontal axis represents time and the vertical axis represents the scanning speed.

### DESCRIPTION OF EMBODIMENTS

Best modes for carrying out the present invention will be described below with reference to the accompanying drawings. However, the present invention is not limited to the following exemplary embodiments. For clarity of explanation, the following description and the drawings are simplified as appropriate.

### First Exemplary Embodiment

A laser build-up apparatus according to a first exemplary embodiment will be described. First, the configuration of the laser build-up apparatus according to the first exemplary embodiment will be described. After the description of the configuration of the laser build-up apparatus is given, a laser build-up method will be described as an example of the operation of the laser build-up apparatus.

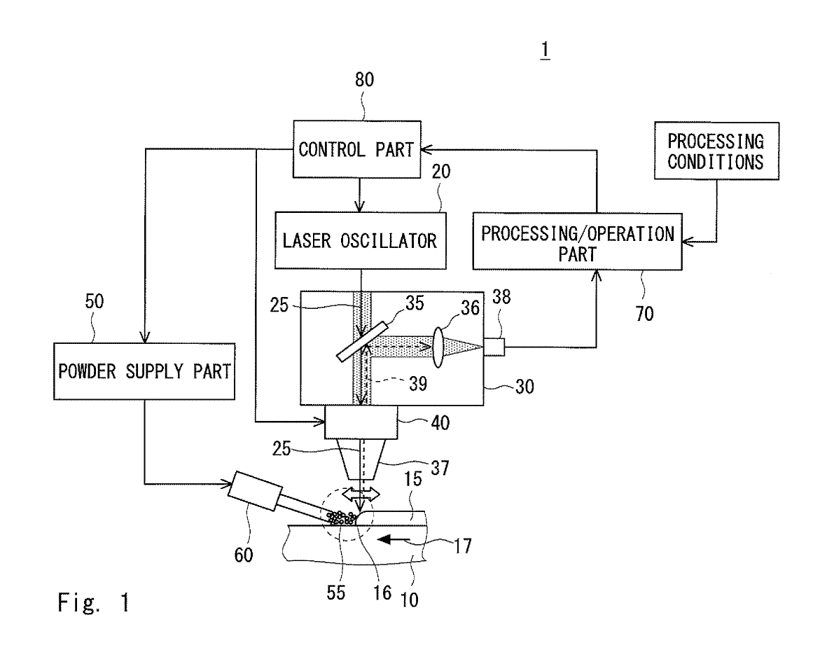

FIG. 1 is a block diagram illustrating the laser build-up apparatus according to the first exemplary embodiment.

As shown in FIG. 1, a laser build-up apparatus 1 is an apparatus that forms a cladding layer 15 on a workpiece 10. The workpiece 10 is, for example, a cylinder head raw material. The workpiece 10 is not limited to the cylinder head raw material.

The laser build-up apparatus 1 includes a laser oscillator 20, a scanner head 30, a mirror lens drive part 40, a powder supply part 50, a nozzle 60, a processing/operation part 70, and a control part 80.

The laser oscillator 20 oscillates a laser 25. The laser oscillator 20 changes the oscillation, interruption, and intensity of the laser 25 by a control signal from the control part 80. The laser oscillator 20 makes the oscillated laser 25 incident on the scanner head 30.

The scanner head 30 includes a mirror 35, a lens 36, a laser head 37, and a radiation thermometer 38. The mirror 35 and the lens 36 are disposed in a housing of the scanner head 30.

The mirror 35 is a half mirror which transmits a part of the incident light and reflects a part of the incident light. The mirror 35 is disposed in the housing in such a manner that the mirror 35 transmits a part of the laser 25 oscillated by the laser oscillator 20 and allows the laser to reach the laser head 37. The mirror 35 is disposed in such a manner that the mirror 35 reflects a part of infrared light 39 input through the laser head 37 on the lens 36.

The lens 36 focuses light. The light is, for example, light including the infrared light 39. The lens 36 is disposed in the housing in such a manner that the lens 36 focuses the infrared light 39 reflected by the mirror 35 on the radiation thermometer 38.

The laser head 37 is attached to a side of the scanner head 30 that is closer to the workpiece 10. The laser head 37 includes a light-emitting port for the laser 25. The laser head 37 is disposed in such a manner that the laser 25 transmitted through the mirror 35 is allowed to reach the surface of the workpiece 10. The light-emitting port of the laser head 37 also functions as a light-incident port for the infrared light 39. The laser head 37 is disposed in such a manner that the infrared light 39 from a melt pool 16 (melted part), which is obtained by melting metallic powder 55 on the workpiece 10 by irradiation of the laser 25, is allowed to reach the mirror 35. The optical axis of the laser 25 and the optical axis of the infrared light 39 from the melt pool 16 may be substantially matched in the laser head 37. In this case, the radiation temperature of the melt pool 16 can be accurately measured.

The radiation thermometer 38 is disposed on a wall surface of the scanner head 30 that is opposed to the lens 36. The radiation thermometer 38 measures the intensity of infrared light or visible light emitted from an object, thereby measuring the temperature of the object. The radiation thermometer 38 measures the intensity of the infrared light 39 focused by the lens 36, thereby measuring the radiation temperature. For example, the intensity of the infrared light 39 from the melt pool 16 on the workpiece 10 is measured to thereby measure the radiation temperature of the melt pool 16. The radiation thermometer 38 outputs information about the measured radiation temperature to the processing/operation part 70.

The mirror lens drive part 40 drives the scanner head 30. The mirror lens drive part 40 drives the scanning head 30 according to a control signal from the control part 80, and scans the laser 25 emitted from the laser head 37. This allows the irradiation position of the laser 25 to move. For example, the mirror lens drive part 40 causes the scanner head 30 to perform weaving (oscillation) to thereby perform a weaving irradiation. In other words, the mirror lens drive part 40 causes the scanner head 30 to oscillate in a direction orthogonal to a direction in which the cladding layer 15 is formed (hereinafter referred to as a clad direction 17) and causes the laser head 37 to move in the clad direction 17.

The mirror lens drive part 40 may cause the workpiece 10 to move in a direction opposite to the clad direction 17 while causing the scanner head 30 to perform weaving (oscillation) in one direction like a pendulum.

The mirror lens drive part 40 performs scanning of the laser 25, interrupts the scanning, and changes the scanning speed according to the control signal from the control part 80.

Since the mirror 35, the lens 36, the laser head 37, and the radiation thermometer 38 are fixed to the scanner head 30, infrared light from the melt pool 16 can be measured by the radiation thermometer 38 through the mirror 35 and the lens 36, even when the scanner head 30 is caused to perform weaving.

The powder supply part 50 supplies the nozzle 60 with the metallic powder 55. The powder supply part 50 supplies the metallic powder 55 mixed in a carrier gas. The metallic powder 55 includes, for example, copper powder. The carrier gas is, for example, an inert gas such as nitrogen or argon. The powder supply part 50 adjusts a supply timing, an interruption timing, and a feed rate of the metallic powder 55 according to the control signal from the control part 80.

The nozzle 60 supplies the workpiece 10 with the metallic powder 55 supplied from the powder supply part 50. The nozzle 60 supplies the metallic powder 55 as well as the carrier gas onto the workpiece 10. The laser 25 is irradiated onto the metallic powder 55 supplied from the nozzle 60 onto the workpiece 10, thereby forming the cladding layer 15. Along with the formation of the cladding layer 15, the nozzle 60 is moved in the clad direction 17. When the workpiece 10 is moved in the direction opposite to the clad direction 17, the nozzle may be fixed.

The processing/operation part 70 receives, from the radiation thermometer 38, information about the radiation temperature measured by the radiation thermometer 38. The processing/operation part 70 compares the radiation temperatures at respective locations of the melt pool 16 with each other from the information about the radiation temperature received from the radiation thermometer 38, and performs an arithmetic operation using the radiation temperatures at each location. The processing/operation part 70 sets an irradiation condition for the laser 25 based on the comparison result and the operation result.

The processing/operation part 70 transmits the set irradiation condition to the control part 80. Conditions for processing the cladding layer 15 are input to the processing/operation part 70. The processing/operation part 70 calculates processing conditions for forming the cladding layer 15 based on the input processing conditions. The processing/operation part 70 transmits the calculated processing conditions for the cladding layer 15 to the control part 80.

The control part 80 transmits the control signal for controlling the supply timing, the interruption timing, and the feed rate of the metallic powder 55 to the powder supply part 50. Further, the control part 80 transmits the control signal for controlling, for example, the oscillation, interruption, intensity, and aperture of the laser 25, and extinction by flashing of the laser, to the laser oscillator 20. Furthermore, the control part 80 transmits the control signal for controlling the movement, interruption, and movement speed of the scanner head 30 to the mirror lens drive part 40. Thus, scanning of the laser 25, interruption of the scanning, and change of the scanning speed are carried out.

The control part 80 transmits, to the mirror lens drive part 40, the control signal for controlling scanning of the scanner head 30 involving weaving, interruption of the scanning, and change of the scanning speed based on the operation result and the result of a comparison of the irradiation temperatures at respective locations of the melt pool 16 with each other that are received from the processing/operation part 70.

Next, a laser build-up method will be described as an example of the operation of the laser build-up apparatus according to this exemplary embodiment.

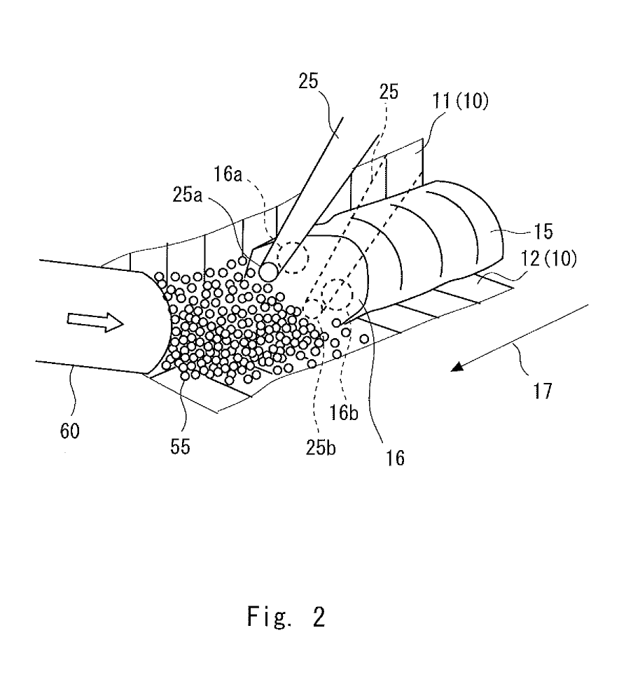

FIG. 2 is a diagram illustrating the laser build-up method according to the first exemplary embodiment.

As shown in FIG. 2, the laser build-up apparatus 1 irradiates the laser 25 onto the workpiece 10 while supplying the workpiece 10 with the metallic powder 55, thereby forming the cladding layer 15. The workpiece 10 includes a corner region formed by a first surface 11 and a second surface 12 in a different orientation from the first surface. This exemplary embodiment illustrates a laser build-up method for such a corner region.

The first surface 11 is, for example, a vertical surface. The second surface 12 is, for example, a horizontal surface. In this case, the corner region is a region formed by intersecting a vertical surface and a horizontal surface with an angle of 90°. The first surface 11 and the second surface 12 intersect each other. The intersection between the first and second surfaces is a line of intersection extending in one direction. One direction in the line of intersection is the direction in which the cladding layer 15 is formed, i.e., the clad direction 17.

First, the metallic powder 55 is supplied to the corner region. The powder supply part 50 supplies the corner region with the metallic powder 55 as well as the carrier gas through the nozzle 60 according to the control signal from the control part 80.

Next, the laser 25 is irradiated on the metallic powder 55 supplied to the corner region. The laser oscillator 20 emits the laser 25 to the mirror 35 of the scanner head 30 according to the control signal from the control part 80. A part of the laser 25 emitted from the laser oscillator 20 is transmitted through the mirror 35 and irradiated on the metallic powder 55, which is supplied to the corner region, through the laser head 37.

The metallic powder 55 irradiated with the laser 25 is melted. A part of the metallic powder 55 that is melted by the laser 25 becomes the melt pool 16 (melted part). The metallic powder 55 is supplied to the melt pool 16 from the nozzle 60. The laser 25 is irradiated on the melt pool 16 from the laser head 37. The nozzle 60 and the laser head 37 are moved in the clad direction 17 while the melt pool 16 is maintained, and the melt pool 16 is moved in the clad direction 17. After the melt pool 16 is moved, the cladding layer 15 is formed.

In this exemplary embodiment, when the laser head 37 is moved in the clad direction 17, the laser head 37 is caused to perform weaving. Specifically, the laser head 37 is caused to advance in the clad direction 17 while the laser head 37 is caused to oscillate in the direction intersecting with the clad direction 17, for example, the direction orthogonal to the clad direction 17. A mirror for controlling the irradiation angle of the laser 25 may be incorporated in the laser head 37 and the mirror may be driven to perform weaving.

By causing the laser head 37 to perform weaving, an irradiation position 25a on the first surface 11 (vertical surface) and an irradiation position 25b on the second surface 12 (horizontal surface) are alternately irradiated with the laser 25. Thus, the laser head 37 performs a weaving irradiation on the first surface 11 and the second surface 12 with the laser 25 under a predetermined irradiation condition, thereby forming the melted part obtained by melting the metallic powder 55.

When the irradiation position 25a on the first surface 11 is irradiated with the laser 25, the infrared light 39 from the irradiation position 25a or a melt pool 16a located in the vicinity of the irradiation position 25a reaches the radiation thermometer 38 through the laser head 37, the mirror 35, and the lens 36. Accordingly, the radiation temperature of the melt pool 16a on the first surface 11 (the temperature is hereinafter referred to as a “first temperature Ta”) can be measured.

When the irradiation position 25b on the second surface 12 is irradiated with the laser 25, the infrared light 39 from the irradiation position 25b or a melt pool 16b located in the vicinity of the irradiation position 25b reaches the radiation thermometer 38 through the laser head 37, the mirror 35, and the lens 36. Accordingly, the radiation temperature of the melt pool 16b on the second surface 12 (the temperature is hereinafter referred to as a “second temperature Tb”) can be measured.

Thus, the radiation thermometer 38 measures the first temperature Ta of the melt pool 16a (melted part) on the first surface 11 and the second temperature Tb of the melt pool 16b (melted part) on the second surface 12. The radiation thermometer 38 transmits the measured first temperature Ta and second temperature Tb to the processing/operation part 70.

The processing/operation part 70 sets the irradiation condition for the laser 25 based on the first temperature Ta and the second temperature Tb transmitted from the radiation thermometer 38. The irradiation condition is set so as to increase or decrease the irradiation energy of the laser 25 irradiated on the first surface 11 and the second surface 12. For example, the irradiation energy can be increased or decreased depending on a laser scanning speed, an interruption time for laser scanning, the intensity of the laser, the aperture of the laser, and focusing of the laser. Accordingly, the irradiation condition includes the laser scanning speed, the interruption time for laser scanning, the intensity of the laser, the aperture of the laser, and focusing of the laser. The irradiation condition may also include the oscillation and interruption of the laser 25, and a supply timing, interruption of the supply, and a feed rate of the metallic powder 55.

For example, when the first temperature Ta is higher than the second temperature Tb, the irradiation energy of the laser 25 on the second surface 12 is set to be larger than the irradiation energy of the laser 25 on the first surface 11. When the first temperature Ta is lower than the second temperature Tb, the irradiation energy of the laser 25 on the first surface 11 is set to be larger than the irradiation energy of the laser 25 on the second surface 12. Specific examples thereof will be described below.

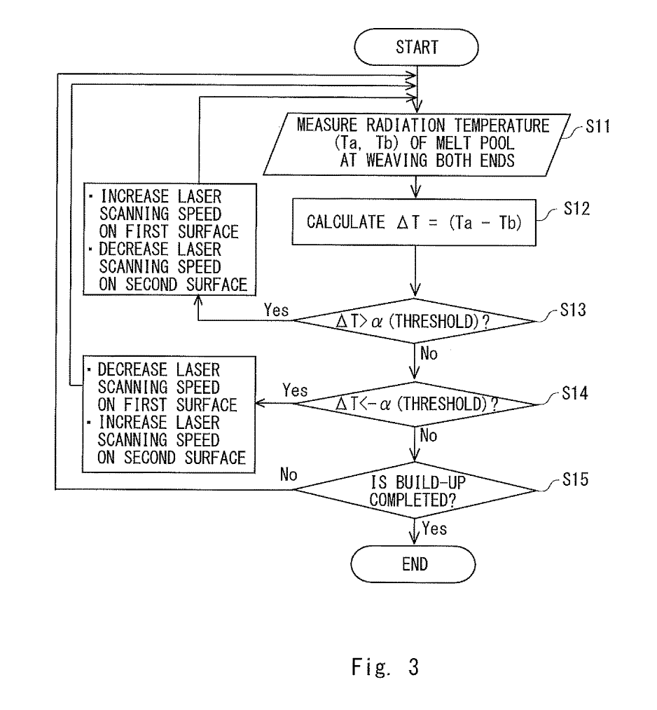

FIG. 3 is a flowchart illustrating a laser build-up method according to the first exemplary embodiment.

As shown in step S11 of FIG. 3, in this exemplary embodiment, the radiation temperature (first temperature Ta) of the melt pool 16a on the first surface 11 and the radiation temperature (second temperature Tb) of the melt pool 16b on the second surface 12 at both ends of an amplitude of weaving are measured.

Next, as shown in step S12, a temperature difference ΔT between the first temperature Ta and the second temperature Tb is calculated. Next, as shown in step S13, it is determined whether the temperature difference ΔT is larger than a threshold α. When the temperature difference ΔT is larger than the threshold α (Yes), the scanning speed of the laser 25 on the first surface 11 is increased and the scanning speed of the laser 25 on the second surface 12 is decreased. Specifically, when the first temperature Ta is higher than the second temperature Tb and the difference obtained by subtracting the second temperature Tb from the first temperature Ta is larger than the predetermined threshold α, the scanning speed of the laser 25 on the first surface 11 is set to be higher than the scanning speed of the laser 25 on the second surface 12. After that, the process returns to step S11 and the first temperature Ta and the second temperature Tb are measured. The threshold α is appropriately set depending on the conditions for processing the cladding layer 15.

On the other hand, when the temperature difference ΔT is smaller than the threshold α (No), as shown in step S14, it is determined whether the temperature difference ΔT is smaller than a threshold (−α). When the temperature difference ΔT is smaller than the threshold (−α) (Yes), the scanning speed of the laser 25 on the first surface 11 is decreased and the scanning speed of the laser 25 on the second surface 12 is increased. Specifically, when the first temperature Ta is lower than the second temperature Tb and the difference obtained by subtracting the first temperature Ta from the second temperature Tb is larger than the predetermined threshold α, the scanning speed of the laser on the first surface 11 is set to be lower than the scanning speed of the laser on the second surface 12. After that, the process returns to step S11 and the first temperature Ta and the second temperature Tb are measured.

On the other hand, when the temperature difference ΔT is larger than the threshold (−α) (No), as shown in step S15, it is determined whether the build-up process is completed. When the build-up process is not completed (No), the laser scanning speed is not changed and the build-up process is continued. Then, the process returns to step S11 and the first temperature Ta and the second temperature Tb are measured. When the build-up process is completed (Yes), the build-up process is terminated. Thus, the laser build-up process for the corner region formed by the first surface 11 and the second surface 12 in a different orientation from the first surface 11 is terminated.

Next, advantageous effects of this exemplary embodiment will be described.

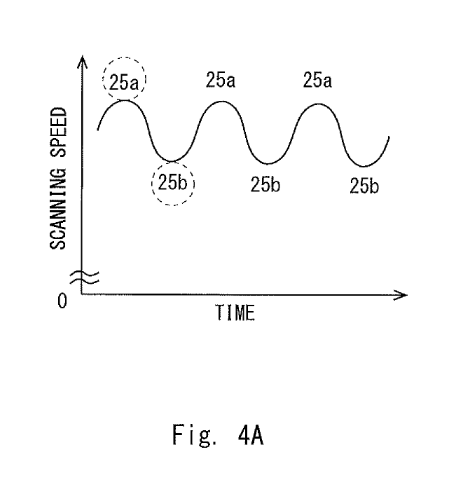

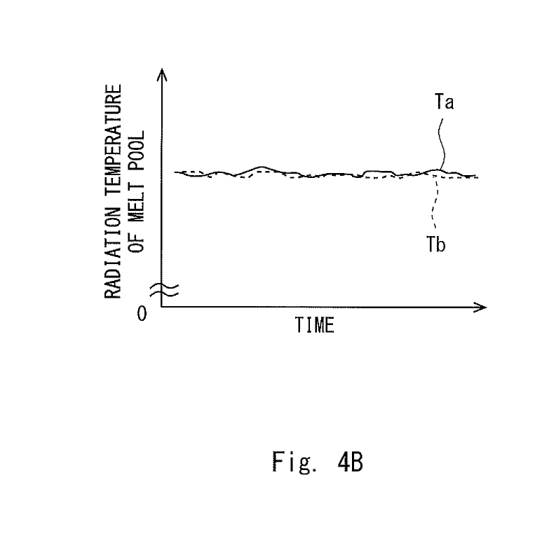

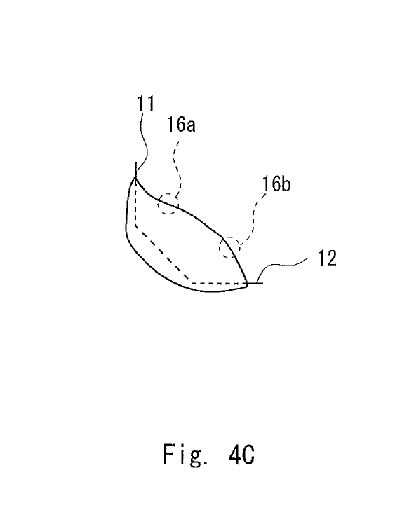

FIG. 4A is a graph illustrating a temporal transition of the scanning speed in the laser build-up method according to the first exemplary embodiment. In FIG. 4A, the horizontal axis represents time and the vertical axis represents the scanning speed. FIG. 4B is a graph illustrating a temporal transition of the radiation temperature of the melt pool in the laser build-up method according to the first exemplary embodiment. In FIG. 4, the horizontal axis represents time and the vertical axis represents the radiation temperature of the melt pool. FIG. 4C is a sectional view illustrating a cladding layer formed by the laser build-up method according to the first exemplary embodiment.

As shown in FIG. 4A, in this exemplary embodiment, the scanning speed of the laser 25 during weaving is changed by the irradiation position of the laser 25. When the first temperature Ta is higher than the second temperature Tb and the difference obtained by subtracting the second temperature Tb from the first temperature Ta is larger than the predetermined threshold α, the scanning speed of the laser 25 at the irradiation position 25a on the first surface 11 is set to be higher than the scanning speed of the laser at the irradiation position 25b on the second surface 12. With this configuration, a time for irradiation of the second surface 12 is increased and a decrease in the temperature of the second surface 12 can be suppressed.

Therefore, the control of the scanning speed in the manner as described above makes it possible to reduce the temperature difference between the first temperature Ta and the second temperature Tb as shown in FIG. 4B. Further, since the temperature difference between the first temperature Ta and the second temperature Tb can be decreased, the weld penetration and thermal effect of the metallic powder 55 on the base material of each of the first surface 11 and the second surface 12 can be made uniform as shown in FIG. 4C. Even when non-uniformity in the distribution of the supplied metallic powder 55 is caused due to the shape of a joint, the effect of gravity, or the like, an interface between the cladding layer 15 and the base material can be formed with a uniform quality and the occurrence of a failure can be suppressed.

When the relation between the first temperature Ta and the second temperature Tb is inverted, specifically, when the first temperature Ta is lower than the second temperature Tb and the difference obtained by subtracting the first temperature Ta from the second temperature Tb is larger than the predetermined threshold α, the scanning speed of the laser 25 on the first surface 11 is set to be lower than the scanning speed of the laser on the second surface 12. A time for irradiation of the first surface 11 is increased and a decrease in the temperature of the first surface 11 can be suppressed. Consequently, the weld penetration and thermal effect of the metallic powder 55 on the base material of each of the first surface 11 and the second surface 12 can be made uniform.

Prior to a more detailed description of the advantageous effects of this exemplary embodiment, comparative examples will be described below. The advantageous effects of this exemplary embodiment will be described by comparing this exemplary embodiment with comparative examples.

### COMPARATIVE EXAMPLE 1

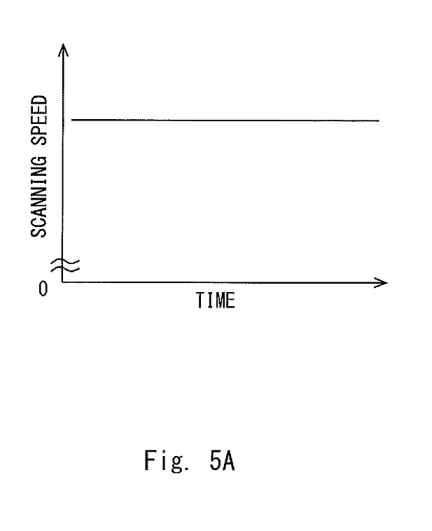

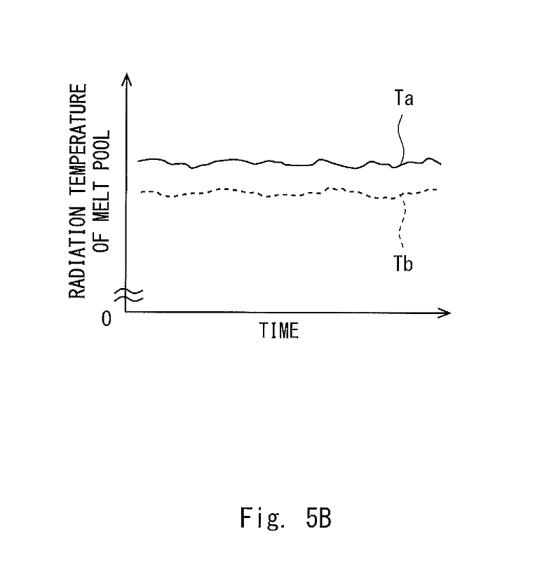

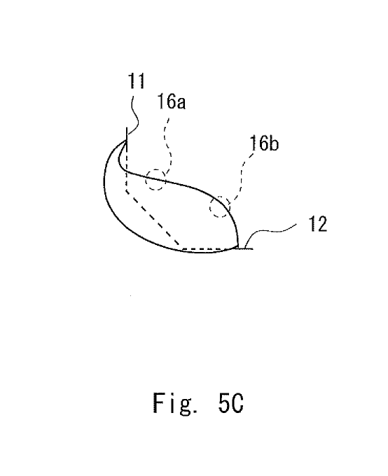

FIG. 5A is a graph illustrating a temporal transition of a scanning speed in a laser build-up method according to Comparative Example 1. In FIG. 5A, the horizontal axis represents time and the vertical axis represents the scanning speed. FIG. 5B is a graph illustrating a temporal transition of a radiation temperature of a melt pool in the laser build-up method according to Comparative Example 1. In FIG. 5B, the horizontal axis represents time and the vertical axis represents the radiation temperature of the melt pool. FIG. 5C is a sectional view illustrating a cladding layer formed by the laser build-up method according to Comparative Example 1.

As shown in FIG. 5A, in Comparative Example 1, the scanning speed of the laser 25 during weaving is not changed by the irradiation position of the laser 25. The scanning speed of the laser 25 on the first surface 11 and the scanning speed of the laser 25 on the second surface 12 are the same and constant. Accordingly, the time for irradiation of the first surface 11 is also the same as the time for irradiation of the second surface 12.

As shown in FIG. 5B, in the case where the time for irradiation of the first surface 11 is the same as the time for irradiation of the second surface 12, if non-uniformity in the distribution of the supplied metallic powder 55 is caused due to the shape of a joint, the effect of gravity, or the like, a temperature difference is generated between the first temperature Ta and the second temperature Tb. For example, when the first surface 11 is a vertical surface and the second surface 12 is a horizontal surface, the second surface 12 may be supplied with a larger amount of the metallic powder 55 due to the effect of gravity.

Then, as shown in FIG. 5C, the amount of the metallic powder 55 on the first surface 11 is decreased and the first temperature Ta is increased by the irradiation of the laser 25, which leads to an increase in weld penetration of the metallic powder 55 with respect to the base material of the first surface 11. Further, the thermal effect is increased. On the other hand, the amount of the metallic powder 55 on the second surface 12 is increased and the second temperature Tb after the irradiation of the laser 25 is decreased, which leads to a decrease in weld penetration of the metallic powder 55 with respect to the base material. Further, the thermal effect is reduced.

Accordingly, the temperature difference between the first temperature Ta and the second temperature Tb is increased, which causes non-uniformity in the weld penetration and thermal effect of the metallic powder 55 on the first surface 11 and the second surface 12. When non-uniformity in the distribution of the supplied metallic powder 55 is caused due to the shape of a joint, the effect of gravity, or the like, non-uniformity in the quality of the interface between the cladding layer 15 and the base material is caused, which makes it difficult to suppress the occurrence of a failure.

On the other hand, in this exemplary embodiment, the scanning speed involving weaving is controlled based on monitoring information about a temperature distribution of the melt pool 16. Thus, in the laser build-up process of melting and stacking the metallic powder 55 on the corner region formed by the first surface 11 and the second surface 12, the qualities (weld penetration and thermal effect) of the interface between stacked layers can be made uniform and the occurrence of a failure can be suppressed even when non-uniformity in the distribution of the supplied metallic powder 55 is caused due to the shape of a joint, the effect of gravity, or the like.

### COMPARATIVE EXAMPLE 2

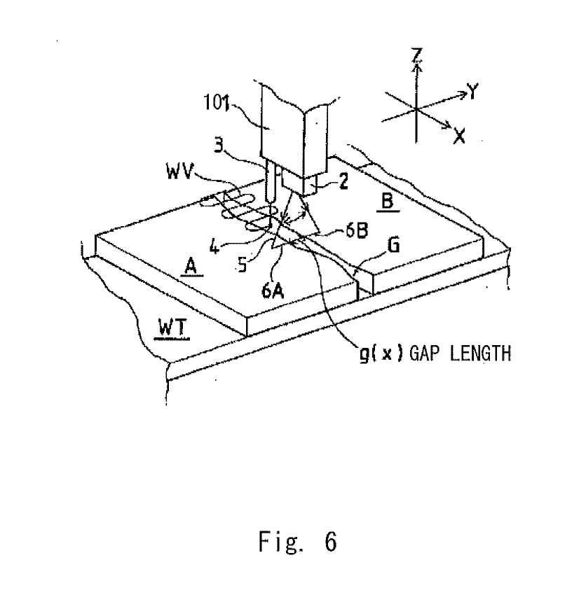

Next, Comparative Example 2 will be described as another comparative example. Japanese Unexamined Patent Application Publication No. H10-244367 discloses a welding method of causing a welding robot to perform weaving and tracking under a condition corresponding to a gap length between a joint A and a joint B. FIG. 6 is a diagram illustrating a laser build-up method according to Comparative Example 2.

As shown in FIG. 6, in this method, a laser sensor 2 and a welding torch 3 are attached to a robot arm endpoint 101 and the joints A and B are welded. The laser sensor 2 performs scanning (6A, 6B) on the surface of each joint with a laser beam 5 and periodically performs detection of a weld line position and detection of a gap length. Sensor current position data with a time stamp is periodically output from the robot to the sensor, and the weld line position is obtained as robot data. A weaving condition corresponding to a range of a detected gap length g(x) is selected, and a torch tip end 4 depicts a trajectory WV on which tracking and weaving are superimposed. The weaving condition is changed at a timing when a disturbance of the trajectory is prevented.

In Comparative Example 2, the weaving trajectory is controlled (selected) according to the location of each joint or a gap between joints, so that the entire joint can be reliably welded. However, it is difficult for Comparative Example 2 to control a variation in welding quality (such as the weld penetration and thermal effect) that is caused by a variation in input heat distribution due to the location of each joint or a gap between joints. This is because the input heat distribution for controlling the welding quality (such as the weld penetration and thermal effect) is not measured and weaving conditions are not controlled.

On the other hand, in this exemplary embodiment, the temperature distribution of the melt pool 16 that has a great effect on the welding quality (such as the weld penetration and thermal effect) is measured in real time and conditions for scanning (such as a speed, an interruption time, and an amplitude) involving weaving is feedback-controlled based on the information. Accordingly, the quality (weld penetration and thermal effect) of the interface between stacked layers can be made uniform and the occurrence of a failure can be suppressed even when non-uniformity in the distribution of supplied powder is caused due to the shape of a joint, the effect of gravity, or the like.

### Second Exemplary Embodiment

Next, a laser build-up method according to a second exemplary embodiment will be described. In this exemplary embodiment, scanning of the laser 25 is interrupted instead of controlling the scanning speed of the laser 25 on the first surface 11 and the second surface 12. The configuration of a laser build-up apparatus according to the second exemplary embodiment is similar to that of the first exemplary embodiment, and thus the description thereof is omitted.

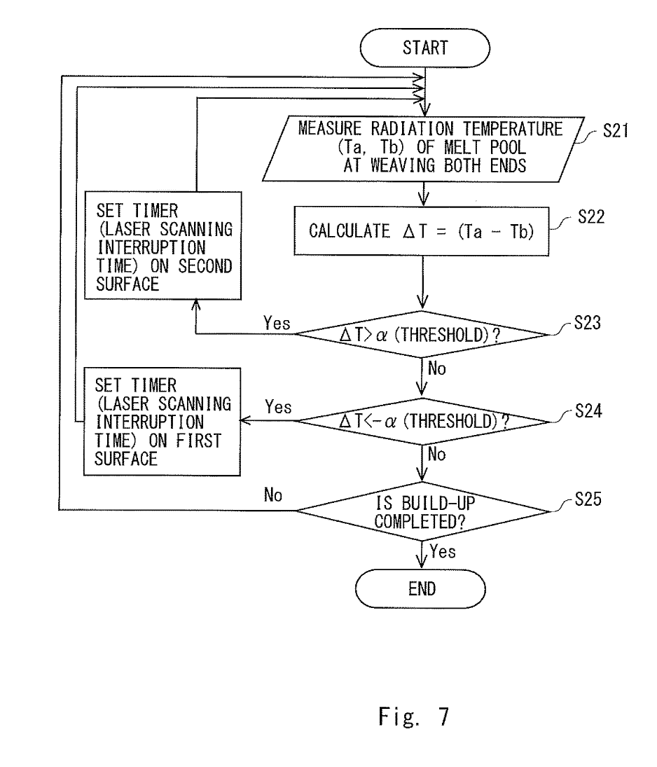

FIG. 7 is a flowchart illustrating the laser build-up method according to the second exemplary embodiment. Steps S21, S22, and S23 shown in FIG. 7 are the same as steps S11, S12, and S13 of the first exemplary embodiment, and thus descriptions thereof are omitted. In step S23, when the temperature difference ΔT is larger than the threshold α (Yes), a timer is set for scanning of the laser 25 while irradiating the laser 25 on the second surface 12. Specifically, scanning of the laser 25 is interrupted for a certain period of time while irradiating the laser 25.

In this manner, when the first temperature Ta is higher than the second temperature Tb and the difference obtained by subtracting the second temperature Tb from the first temperature Ta is larger than the predetermined threshold, scanning of the laser 25 is interrupted for a certain period of time on the second surface 12. After that, the process returns to step S21 and the first temperature Ta and the second temperature Tb are measured.

On the other hand, when the temperature difference ΔT is smaller than the threshold α (No), as shown in step S24, it is determined whether the temperature difference ΔT is smaller than the threshold (−α). When the temperature difference ΔT is smaller than the threshold (−α) (Yes), the timer is set for scanning of the laser 25, while irradiating the laser on the first surface 11. Specifically, scanning of the laser 25 is interrupted for a certain period of time. Thus, when the first temperature Ta is lower than the second temperature Tb and the difference obtained by subtracting the first temperature Ta from the second temperature Tb is larger than the predetermined threshold, scanning of the laser 25 is interrupted for a certain period of time on the first surface 11. After that, the process returns to step S21 and the first temperature Ta and the second temperature Tb are measured.

When the temperature difference ΔT is larger than the threshold (−α) (No), as shown in step S25, it is determined whether the build-up process is completed. When the build-up process is not completed (No), the laser scanning speed is not changed and the build-up process is continued. Then, the process returns to step S21 and the first temperature Ta and the second temperature Tb are measured. When the build-up process is completed (Yes), the build-up process is terminated. Thus, the laser build-up process for the corner region formed of the first surface 11 of the second surface 12 in a different orientation from the first surface 11 is terminated.

Next, advantageous effects of this exemplary embodiment will be described.

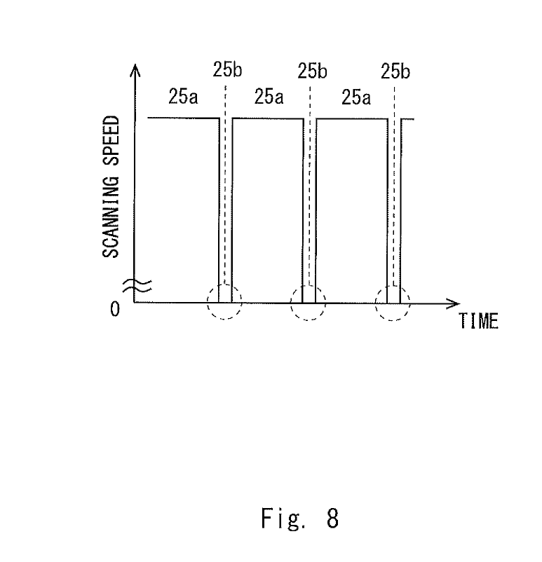

FIG. 8 is a graph illustrating a temporal transition of the scanning speed in the laser build-up method according to the second exemplary embodiment. In FIG. 8, the horizontal axis represents time and the vertical axis represents the scanning speed.

As shown in FIG. 8, in this exemplary embodiment, the scanning speed of the laser 25 involving weaving is changed by the irradiation position of the laser 25. When the first temperature Ta is higher than the second temperature Tb and the difference obtained by subtracting the second temperature Tb from the first temperature Ta is larger than the predetermined threshold α, scanning of the laser 25 is interrupted for a certain period of time at the irradiation position 25b on the second surface 12. With this configuration, a time for irradiation of the second surface 12 is increased and a decrease in the temperature of the second surface 12 can be suppressed.

Therefore, the control of the scanning speed makes it possible to reduce the temperature difference between the first temperature Ta and the second temperature Tb as shown in FIG. 4B. Further, as shown in FIG. 4C, the weld penetration and thermal effect of the metallic powder 55 on the base material of each of the first surface 11 and the second surface 12 can be made uniform. Consequently, the quality of the interface between the cladding layer 15 and the base material can be made uniform and the occurrence of a failure can be suppressed even when non-uniformity in the distribution of the supplied metallic powder 55 is caused due to the shape of a joint, the effect of gravity, or the like.

When the relation between the first temperature Ta and the second temperature Tb is inverted, specifically, when the first temperature Ta is lower than the second temperature Tb and the difference obtained by subtracting the first temperature Ta from the second temperature Tb is larger than the predetermined threshold, scanning of the laser 25 is interrupted for a certain period of time on the first surface 11. With this configuration, a time for irradiation of the first surface 11 is increased and a decrease in the temperature of the first surface 11 can be suppressed. The other advantageous effects are similar to those of the first exemplary embodiment.

While exemplary embodiments of the laser build-up method according to the present invention have been described above, the present invention is not limited to the configurations described above and can be modified without departing from the technical idea of the present invention.

For example, the angle formed between the first surface 11 and the second surface is not limited to 90°. The angle formed between the first surface 11 and the second surface 12 can be applied to a corner region having any angle such as an acute angle or an obtuse angle. The first surface 11 is not limited to a vertical surface and the second surface is not limited to a horizontal surface. A V-shaped corner region may be formed by inclining the first surface 11 and the second surface 12 from the horizontal orientation.

The workpiece 10 is not limited to a valve seat of a cylinder head, but instead can be applied to, for example, the formation of a cladding layer on the workpiece 10 that is required to have a heat resistance or an abrasion resistance under a high temperature environment.

The first and second exemplary embodiments can also be applied to a case where the laser 25 is caused to perform weaving in one direction like a pendulum and the workpiece 10 is moved in a direction opposite to the clad direction 17. In this case, a combination of the speed of weaving in one direction and the movement speed of the workpiece 10 may be used as the scanning speed in the first and second exemplary embodiments. Specifically, when the scanning speed is decreased, for example, an adjustment is made to decrease both the weaving speed and the movement speed of the workpiece 10.

Note that the term “speed” in the exemplary embodiments may indicate a rate.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A laser build-up method for a corner region formed by a first surface and a second surface in a different orientation from the first surface, the laser build-up method comprising:
supplying metallic powder to the corner region;
forming a melted part by performing a weaving irradiation of a laser on the first surface and the second surface under a predetermined irradiation condition and melting the metallic powder;
measuring a first temperature of the melted part of the first surface and a second temperature of the melted part of the second surface; and
setting the irradiation condition based on the first temperature and the second temperature.

2. The laser build-up method according to claim 1, wherein when the first temperature is higher than the second temperature, an irradiation energy of the laser on the second surface is set to be larger than the irradiation energy of the laser on the first surface, and when the first temperature is lower than the second temperature, the irradiation energy of the laser on the first surface is set to be larger than the irradiation energy of the laser on the second surface.

3. The laser build-up method according to claim 1, wherein
when the first temperature is higher than the second temperature and a difference obtained by subtracting the second temperature from the first temperature is larger than a predetermined threshold, a scanning speed of the laser on the first surface is set to be higher than the scanning speed of the laser on the second surface, and
when the first temperature is lower than the second temperature and a difference obtained by subtracting the first temperature from the second temperature is larger than the predetermined threshold, the scanning speed of the laser on the first surface is set to be lower than the scanning speed of the laser on the second surface.

4. The laser build-up method according to claim 1, wherein
when the first temperature is higher than the second temperature and a difference obtained by subtracting the second temperature from the first temperature is larger than a predetermined threshold, scanning of the laser is interrupted for a certain period of time on the second surface, and
when the first temperature is lower than the second temperature and a difference obtained by subtracting the first temperature from the second temperature is larger than the predetermined threshold, scanning of the laser is interrupted for a certain period of time on the first surface.
